(19) United States
(12) Patent Application Publication
(10) Pub. No.: US 2011/0114725 A1
(43) Pub. Date: May 19, 2011

(54) SIGHT SYSTEM WITH AUTOMATIC AIMPOINT COMPENSATION

(76) Inventor: Nicholas E. Young, Murray, UT (US)

(21) Appl. No.: 12/620,423

(22) Filed: Nov. 17, 2009

(51) Int. Cl. G06G 7/80

(52) U.S. Cl. 235/407

(57) ABSTRACT

An optical sighting system includes an optical sight having a projected aiming point, a range finder configured to determine a range of an intended impact point, at least one environmental sensor configured to sense at least one environmental condition, and a computing device in communication with the range finder and the environmental sensor to receive the range and the environmental condition from the range finder and the environmental sensor respectively. The computing device includes a computer readable medium having instructions encoded thereon that when executed perform steps for calculating a compensated position for the projected aiming point based on the range and the environmental condition, and providing instructions to an aimpoint compensator to automatically move the projected aiming point to the compensated position.

### BACKGROUND

1. The Field of the Invention

The present application generally relates to sight systems for use with firearms and to sight systems with automatic aim point compensation.

2. The Relevant Technology

Modern firearms make use of cartridges that include a projectile seated in a casing. The casing has an internal cavity defined therein that contains a charge of rapidly combusting powder. A primer is seated in a recess formed in a rear portion of the casing. A hole in the primer casing places the primer in communication with the internal cavity containing the power. A projectile is seated in the front portion of the casing such that the powder is more or less sealingly contained in the casing between the primer and the projectile.

An action, such as a bolt action, is used to advance the cartridge into a firing chamber ahead of firing. While in the firing chamber, a firing pin strikes the primer, causing the primer to ignite. The ignition is directed to the powder, which burns within the casing. The powder burns within the casing generates a rapidly expanding gas. The pressure generated by the rapidly expanding gas propels the projectile from the casing and through the barrel of the firearm. A sight is used to allow an operator to aim the projectile to the desired impact point. For example, optical sights are often used that make use of an aiming point that is projected onto the target.

In particular, the aiming point is often set or zeroed to correspond with a desired distance under known conditions. For example, it is not uncommon for an operator to “zero” the aiming point at 100 yards, 200 yards, or some other known distance by adjusting the aiming point until the impact points of the projectiles correspond closely with the aiming point. The positioning of the aiming point under these conditions can be referred to as an initial zero point and the distance can be referred to as a reference distance.

Most of the time, in real word conditions the target is not located at the same range as the reference distance. Accordingly, an operator must compensate for the difference in distance the target is from the reference distance. In order to properly compensate for the difference in range, often the operator must first determine the actual range. This is often done by a visual estimation. Other environmental conditions can also be considered that affect the trajectory of the projectile.

Some of the factors that can affect trajectory of the projectile include factors associated with the firing of the projectile and factors that act on the projectile after it has left the muzzle. Factors that can affect the projectile during firing can include, among others, variable forces on the barrel, variations of the position of cartridges relative to the firing chamber and/or relative to the barrel, variations in the combustion of the powder charge including environmental conditions such as barometric pressure, powder temperature, ambient temperature, and other environmental conditions. Ambient temperature, barometric pressure, wind and other factors can also affect the trajectory of the projectile after it has left the muzzle. These factors as well as the range are often considered and then the operator determines how to compensate for these factors. Generally, all of the factors can be combined to provide corrections in the two primary axes in the optic. Compensation in the vertical axis are referred to as elevation adjustments and compensation along the horizontal axis are referred to as windage adjustments, regardless of the complexities or other contributing factors.

One method of making range and windage adjustments includes placing the aiming point at an appropriate distance from the intended impact point. For example, if the range of the target is beyond the zeroed point, an operator will often simply position the aiming point above the intended impact point to compensate for the difference in range. While such a method can provide some amount of compensation, it can be relatively inaccurate.

In order to increase the accuracy and repeatability of range and windage adjustments many sight systems include adjustment knobs that allow a user to move the aiming point a known amount from the previously established zero, often by a known angular displacement such as ¼ minute of angle. Accordingly, once an operator has determined appropriate elevation and windage adjustments, the operator then rotates the knobs an appropriate distance to achieve the desired adjustments and then places the aiming point on the target. While such an approach can allow repeatability by using an established zero point, it can be tedious to move the aiming point for different conditions. In particular, for reliability an operator often returns the aiming point to a known reference point, such as the zero point, and then rotates in the appropriate adjustments relative to the known reference point, thereby increasing time associated with accurate follow-up shots.

The subject matter claimed herein is not limited to embodiments that solve any disadvantages or that operate only in environments such as those described above. Rather, this background is only provided to illustrate one exemplary technology area where some examples described herein may be practiced.

### BRIEF SUMMARY OF THE INVENTION

An optical sighting system includes an optical sight having a projected aiming point, a range finder configured to determine a range of an intended impact point, at least one environmental sensor configured to sense at least one environmental condition, and a computing device in communication with the range finder and the environmental sensor to receive the range and the environmental condition from the range finder and the environmental sensor respectively. The computing device includes a computer readable medium having instructions encoded thereon that when executed perform steps for calculating a compensated position for the projected aiming point based on the range and the environmental condition, and providing instructions to an aimpoint compensator to automatically move the projected aiming point to the compensated position.

This Summary is provided to introduce a selection of concepts in a simplified form that are further described below in the Detailed Description. This Summary is not intended to identify key features or essential characteristics of the claimed subject matter, nor is it intended to be used as an aid in determining the scope of the claimed subject matter.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIGS. 1A and 1B are schematic diagrams of an automatic aiming point compensation system according to one example;

FIG. 2 illustrates a schematic view of an system for determining aiming point compensation system according to one example;

FIG. 3 is a schematic diagrams of an automatic aiming point compensation system according to one example; and

FIG. 4 illustrates a schematic diagram of magazine/cartridge thermometer according to one example.

### DETAILED DESCRIPTION OF THE PREFERRED EMBODIMENTS

Systems and methods are provided herein for use with firearms for positioning a projected aiming point on an intended target or intended impact location automatically while taking into account range and a plurality of environmental conditions. For example, a system can include a computing device having an aim point compensation module and a processor. The computing device receives input from a plurality of sensors to determine the position an aiming point should positioned relative to a reference datum. The plurality of sensors can include a range finder and a plurality of environmental sensors such as pressure, temperature, wind, and/or other types of sensors. The system is also configured to receive input(s) to select an intended target and to automatically move the projected aiming point to a compensated aiming location to account for the environmental conditions and the range of the intended impact point. With the projected aiming point at a relative position that takes into account relevant factors, an operator can focus on maintaining the projected aiming point on the intended target, which can help improve the accuracy by reducing errors associated with estimations as well as errors associated with manually dialing in corrections that take into account the factors discussed above. Further, such a configuration can help reduce the time associated with compensating for environmental conditions, thereby allowing an operator to quickly and accurately aim the firearm to hit the intended target.

In other examples, the system can receive inputs from environmental sensors and a range finder and use information from ballistic tables to calculate a compensated position for the projected aiming point relative to a known reference. Thereafter, the system can provide the corrections to the operator, such as by way of a visual output, after which the operator can then dial in the adjustments manually. For ease of reference, a system will be described below in which the adjustments are made automatically, though it will be appreciated that same discussion can be applied to a system that calculates the adjustments and provides the adjustments by way of an output, such as visual and/or audio output.

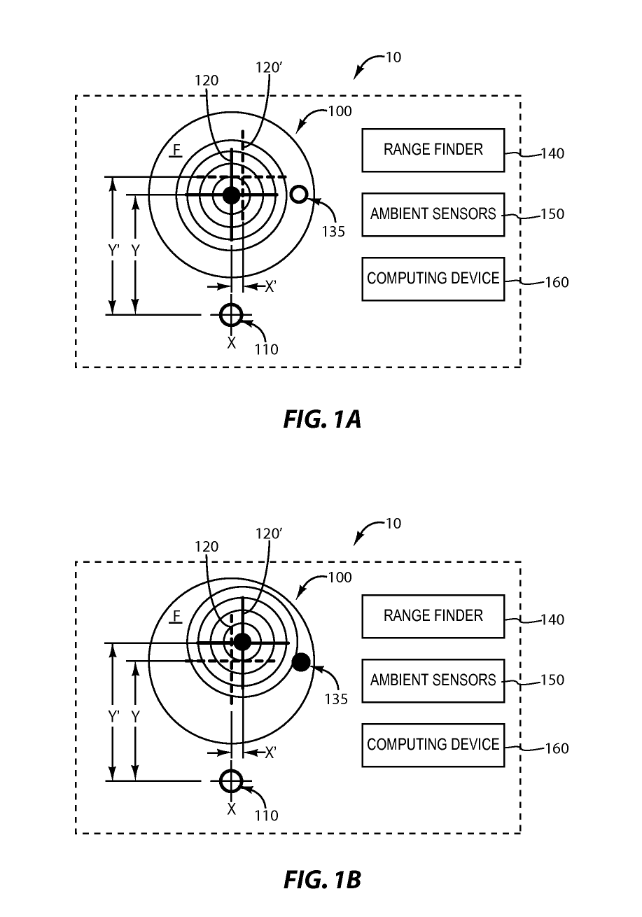

FIGS. 1A and 1B are schematic diagrams introducing one example of automatically moving a projected aiming point to a compensated position according to one example. In particular, FIG. 1A illustrates an automatically compensating targeting system 10 that generally includes an optical sight 100 with a projected aiming point positioned within a visible field F. The position of a projected aiming point can be described relative to a known reference datum 110 and is represented as position X, Y from the reference datum 110. The reference datum 110 can be any repeatable datum, such as an axis, point, plane or other type of reference.

A projected aiming point will be described as having at least two states. These states include an initial or acquisition aiming point 120 shown in FIG. 1A at position X, Y relative to the reference datum 110 and a compensated aiming point 120′ shown in FIG. 1B at position X′, Y′ relative to the same reference datum 110. Although a single projected aiming point can be moved between the two states. For ease of reference, while the projected aiming point is in an acquisition state, the projected aiming point will be described as an acquisition aiming point. In such a position, the location of the aiming point has not been confirmed as being at a compensated position. Once the location of the projected aiming point has been confirmed as being in a compensated position, such as after the automatically compensating aiming system has moved the projected aiming point to a compensated position, the projected aiming point will thence be referred to as a compensated aiming point.

Referring to FIG. 1A, if an operator desires to fire a projectile at an intended target, typically the operator first acquires the target. In order to acquire the target, the operator moves the optical sight 100 to position the intended impact point 130 within the optical field F. Such a situation is shown in FIG. 1A, where the intended impact point 130, represented by a central circle of a bull's eye type target, is positioned within the optical field F.

In at least one example, the automatically compensating targeting system 10 provides a visual indication of whether the projected aiming point is in an acquisition state or whether the projected aiming point is in a compensated state. The visual indication is shown schematically as a visual indicator represented as empty circle 135 displayed within the optical field F. It will be appreciated that any other type of visual indicator, such as lights or other projections, can be provided and positioned at any desired location inside or outside of the optical field or the visual indicator can be omitted entirely as desired.

Continuing with FIG. 1A, once an operator has the intended impact point 130 within the optical field F, the operator then places the acquisition aiming point 120 on the intended impact point 130. In at least one example, an operator can provide an input causing the system to determine the range of the intended impact point 130. In at least one example, the user can provide input indicating the acquisition aiming point 120 is on the intended impact point 130 within the optical field F.

The compensating targeting system 10 can then sense environmental and/or other factors as well as the range of the intended target before, during, and/or after the acquisition aiming point is on the intended impact point 130. Accordingly, the automatically compensating targeting system 10 can include and/or be operatively associated with a range finder (represented schematically as 140) and a number of environmental sensors (represented schematically and collectively as ambient sensors 150).

The automatically compensating targeting system 10 includes and/or is operatively associated with a computing device 160 that processes the inputs to determine how the environmental conditions and/or range affect the projectile. The computing device also calculates a position of the projected aiming point relative to the reference datum 110 that would cause the projected aiming point 120 to correspond to the intended impact point 130. The automatically compensating targeting system 10 then automatically moves the projected aiming point relative to the reference datum 110, if appropriate, as shown in FIG. 1B, such that the projected aiming point is in a compensated aiming point 120′. Once the compensating targeting system 10 has moved the projected aiming point to a compensated position, the system can be referred to as being configured for compensated direct aiming, in which the projected aiming point corresponds to an estimated impact point. For ease of reference, the position of the compensated aiming point 120′ is overlaid in FIG. 1A. Accordingly, if the position X′, Y′ of the compensated aiming point 120′ relative to the reference datum 110 for the intended impact point 130 is different than the position X, Y of the acquisition aiming point 120 (FIG. 1A), the automatically compensating targeting system 10 will automatically change the position of the projected aiming point as appropriate.

A projected aiming point can be moved relative to the reference datum 110 in any suitable manner. In at least one example, a projected aiming point can be electronically projected within the optical field F. In such an example, the electronic projection of the projected aiming point can be varied within the optical field to place the projected aiming point at an appropriate position. In other examples, the automatically compensating targeting system 10 can include mechanisms for physically moving the entire optical field F and/or the entire optical sight 100 relative to the reference datum 110 to thereby position the projected aiming point at an appropriate position. Other configurations are also possible to automatically move the position of a projected aiming point to compensate for environmental conditions and/or range, including combinations of varying projection and moving the entire optical field F.

Automatically moving the projected aiming point to a compensated position can allow an operator to rapidly orient a firearm using the optical sight to hit an intended target while placing the projected aiming point directly on the intended target. Such a configuration can reduce error associated with manually inputting windage and elevation adjustments in a first instance and can further reduce errors associated with manually inputting subsequent adjustments as a return to a known zero can optionally be omitted.

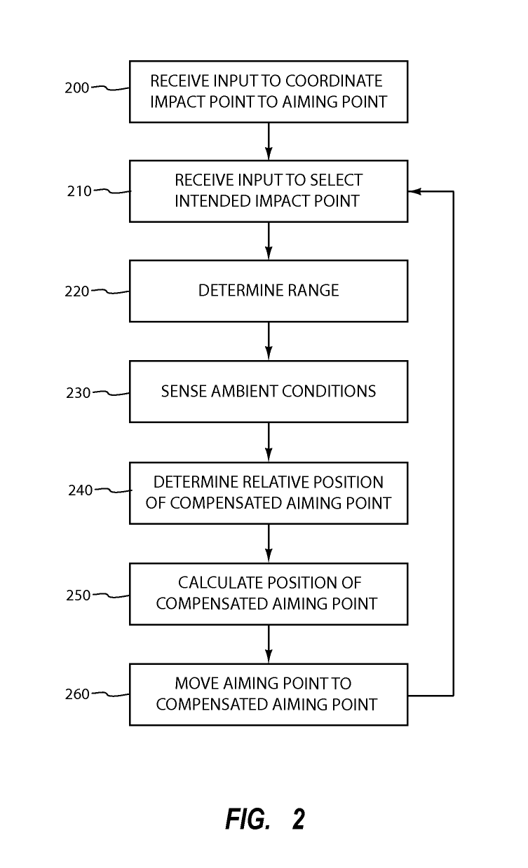

In at least one example, the visual indicator can switch between an acquisition indicator to a compensated indicator when the projected aiming point has been moved to a compensated position. A compensated indicator is represented schematically by the full circle 135′. Such a configuration can provide an operator assurance that a projected aiming point is at a compensated position and thereby provide assurance to the operator of the accuracy of a shot at an intended target. Any suitable method can be used in determining how to move the projected aiming point to a location that compensates for environmental conditions and range. One exemplary method will be described in more detail with reference to FIG. 2

FIG. 2 is a flowchart illustrating one method for an automatically compensating targeting system (system) to automatically move a projected aiming point relative to a known reference datum to automatically moved to a position that compensates for range and one or more environmental conditions. As illustrated in FIG. 2, the method can include the system initially receiving input to correlate the projected aiming point to an actual impact point, as represented by block 200. In at least one example, this step can include firing projectiles at a target using a projected aiming point, comparing the projected aiming point to the actual impact point, and adjusting the position of the projected aiming point until the projected aiming point, as viewed by an operator, sufficiently corresponds to the actual impact point.

The step of initially establishing correspondence between a projected aiming point and an intended impact point can further include determining the environmental conditions as well as the range at which the impact point is coordinated to the projected aiming point. Additionally, the position of the projected aiming point relative to the known reference datum, such as a point, a plane, or axis, is also determined. Accordingly, such a step determines the position of the projected aiming point relative to the known reference datum that causes a projectile to hit an intended target at a given range and under known environmental conditions. The conditions at which the projected aiming point corresponds to the intended impact point can be referred to as reference conditions and the position of the projected aiming point can be described as a reference position. Any reference range(s) and condition can be used. Further, the method can include any number of these initial steps of establishing reference positions with corresponding reference conditions.

Reference positions and reference conditions can be used to move the projected aiming point to positions which compensate for differences between the reference conditions and current environmental conditions for each shot. More specifically, each of several factors, including the range, environmental conditions, ballistic factors, and other factors contribute in calculable and predictable ways on the firing of the projectile and/or how the projectile travels after it is fired. Since each reference position includes corresponding reference conditions, calculating a position which compensates for differences in range and environmental conditions can include calculating a difference between each of the reference conditions and each of the corresponding current conditions. The difference between the reference conditions and the current conditions can then be used to calculate a difference in the position between the reference position and a position that compensates for the current condition, which can then be used to readily calculate a compensated position.

In at least one example, the system can provide an indication as to whether or not the projected aiming point is at a position that compensates for the effects of environmental conditions and range. In other words, the system can provide an indication of whether the projected aiming point is positioned to allow the operator to hit the intended target by firing while placing the projected aiming point directly on the intended target.

Before the correspondence between the projected aiming point and an actual and/or intended impact point has been established, the system can provide a default indicator state, which can indicate that the system has not received input indicating the system is providing compensated direct aiming. A second indicator state can be provided indicating that correspondence between the projected aiming point and an intended and/or actual impact point has been established and thus that the projected aiming point is at a compensated position.

For ease of reference, the visual indicator will be described as being visible to the operator in the optical field of the optical aiming system, though it will be appreciated that other configurations are possible that indicates that the system has not performed calculations and/or movements to position the projected aiming point at a compensated position relative to the reference datum. The determination of which indicator state is appropriate can be performed automatically by the system or can be input by an operator. One such determination can be made when the system receives input indicating that an intended impact point and the position of the projected aiming point have been initially established, as described above. Other events can include a determination made by the system that the projected aiming point has been moved as appropriate based on the range, environmental conditions, and reference data gleaned from previous shots. The system can also then switch the visual indicator from the second indicator state to the default indicator state based on whether the system senses any number of events, including events related to firing a projectile and/or cycling the action of the firearm, as will be appreciated by those skilled in the art.

According to one such example, if the system receives an input indicating correspondence has been established between the projected aiming point and the actual aiming point as described above, the system will again switch the visual indicator to the second state to provide notice that the position of the projected aiming point is compensated for the intended impact point.

Accordingly, with the reference position of the projected aiming point known under reference condition, the compensated position of the projected aiming point corresponding to a different intended impact point at a different range and/or under different environment conditions can be readily determined. In particular, for subsequent shots the range is determined as represented by block 210. In at least one example, determining the range can include using a rangefinder associated with the optical aiming system. For example, the rangefinder can be integrated with the optical portion of the aiming system such that an operator places the projected aiming point over the intended target to allow an operator to acquire the range.

Additional environmental conditions that may affect the trajectory of a projectile can also be sensed before, simultaneously, and/or after a range is determined, as represented by block 220. These environmental conditions can include, but are not limited to, ambient temperature, cartridge temperature, relative humidity, barometric pressure, wind speed, wind direction, and/or any other environmental conditions that can affect the trajectory of a projectile.

As represented by block 230, the method can also include receiving additional input from an operator. For example, the method can also include receiving information related to the size and/or shape of the projectile, ballistic coefficient, the type and/or amount of powder, and/or any other information that may be desirable.

The position for a compensated projected aiming point is then calculated, as represented by block 240. In at least one example, the position of the compensated projected aiming point can be calculated by determining differences between the range and environmental conditions for the current intended target and previous reference conditions and the corresponding reference positions for the projected aiming point. Such circumstances have been described as being established above as an initial step. Accordingly, in at least one example the position of the compensated aiming point for a given point can be calculated based on differences between previously sensed range(s) and environmental conditions and those currently sensed. Since the position of the previously compensated aiming point is known relative to the reference datum, a current compensated position of the aiming point can be calculated by calculating the differences, if any, between the range and environmental conditions, calculating the cumulative effect those differences would have on the trajectory of the projectile, and then calculating the windage and elevation differences as appropriate.

As previously introduced, the correlation of the projected aiming point and the intended aiming point can be established under any set of circumstances. Accordingly, such a configuration allows for setup under a wide variety of circumstances as no preset range is used as a ‘zero’ range as the range and environmental conditions can be sensed continuously and when input is received that the position of the projected aiming point corresponds to the intended aiming point, the correspondence can be noted and used for subsequent calculations.

Once the position of the compensated aiming point is calculated, the system can then automatically move the projected aiming point to the compensated aiming position, as represented by block 250. In at least one example, projected aiming point can be moved to the compensated position by moving the projected aiming point using the corrections provided by comparing the reference conditions and corresponding reference position(s) with the current conditions.

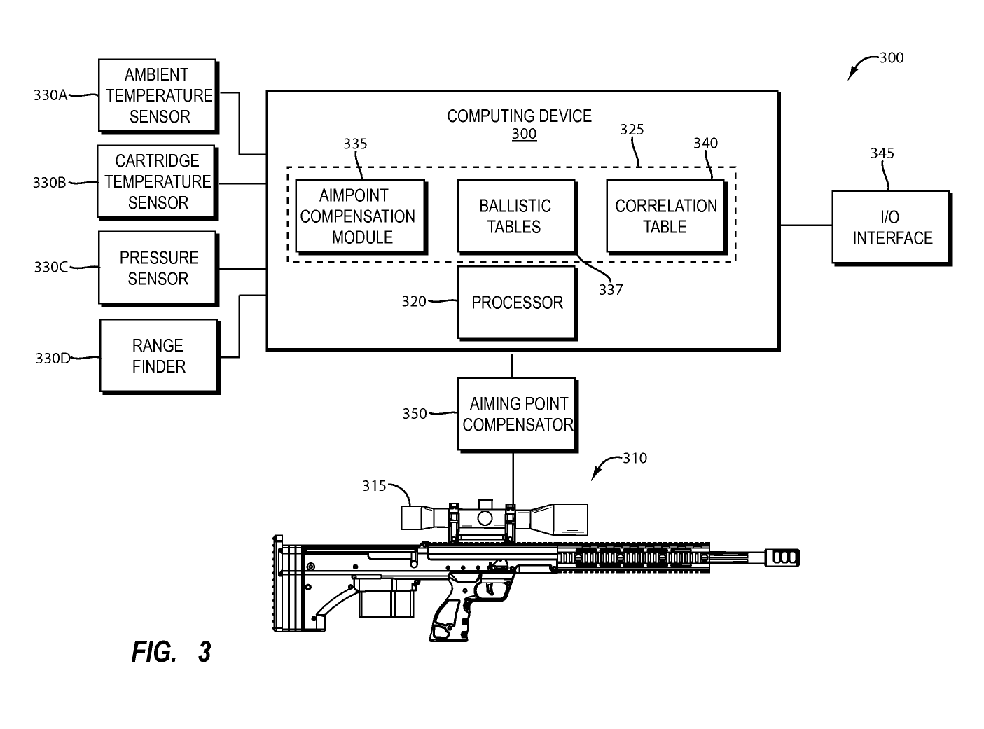

FIG. 3 illustrates a schematic view of a conventional firearm system 30 that includes an automatic aiming point compensation control system 300 residing on or associated with a computing device 305 and a firearm, such as a rifle 310 having an optical sight 315. While the rifle and the automatic aiming point compensation control system 300, the rifle 310, and the optical sight 315 are shown as separate components, it will be appreciated that any of the components described below can be integrated with or associated with other components and are separated for ease of reference only.

With continuing reference to FIG. 3, the computing device 305 can include a processor 320 and a computer readable medium, such as a storage device 325 in communication with a processor 320. The storage device 325 can include read only memory as well as random access memory. Instructions and data can reside on the storage device 325 and be accessed by the processor 320 to perform the operations described below. For ease of reference, the operations will be described as being performed by the aimpoint compensation module 335, though it will be appreciated that the processor 320 cooperates with the various components of the system to execute the calculations and perform the steps described below.

In particular, environmental sensors, such as an ambient thermometer 330A, a cartridge/magazine thermometer 330B, a barometer 330C, a wind sensor 330D as well as any number of other sensors as well as a rangefinder 140 can be operatively associated with the aimpoint compensation module 335.

In the illustrated example, a aimpoint compensation module 335 includes ballistic tables 337, a correlation table 340, and an adjustment execution module 342. These modules can reside on the storage device 325 or in other memory locations. The aimpoint compensation module 335 is configured to receive the input from the sensors 330A-330D as well as the rangefinder 140. If applicable, the aimpoint compensation module 335 can also receive information about a position of a projected aiming point relative to a known reference datum, as described in more detail above. The processor 320 can also receive input from an I/O interface 345. This input can include manual corrections or estimates, reset/initialization instructions, and/or any other input that may be desirable. In at least one example, the input can be stored in RAM for ready access by the aimpoint compensation module 335.

Accordingly, in at least one example, the aimpoint compensation module 335 can receive input from the I/O interface 345 as well as information from sensors 330A-330D and/or the rangefinder 140. Such a configuration can allow a user to correlate the position of a projected aiming point in an initial step as described above and then store the associated ambient conditions associated with that correlation in the correlation table 340. This may be performed as often or as few times as desired. Further, the aimpoint compensation module 335 can include instructions for initializing or resetting the correlation table 340 as desired.

After information has been stored in the correlation table 340 during an initial step, the aimpoint compensation module 335 then uses the information on the ballistic tables 337 to calculate how ambient conditions and/or any other the other received input affects the trajectory of a projectile. The aimpoint compensation module 335 compares information on how the ambient conditions/inputs affects the trajectory of a projectile with the information stored on the correlation table 340 and the ballistic tables 337 to determine adjustments to be made to relative position of the projected aiming point. The aimpoint compensation module 335 then directs an adjustment module 350 to adjust the projected aiming point to an appropriate position, as described above. Any of the approaches for moving the position of the projected aiming point described above as well as any other suitable approach can be used as desired. The ballistic tables can include data for any number of powder types, weight, ballistic coefficients and/or other data for any number of projectiles and/or any other components; and/or data for complete cartridges for any number of calibers. Accordingly, the system 300 is configured to automatically move the aiming point of an optical targeting system according to ambient as well as range conditions.

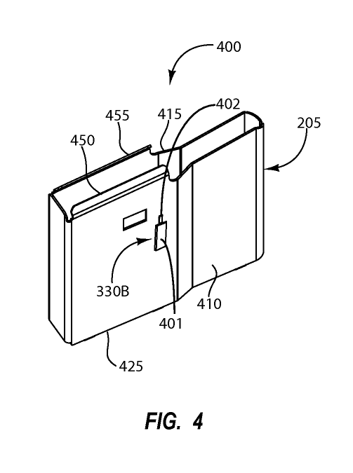

In at least one example, one environment sensor can include a cartridge/magazine thermometer 330B. A combination cartridge/magazine thermometer 330B is shown in more detail in FIG. 4. As illustrated in FIG. 4, the cartridge/magazine thermometer 330B can be secured to a magazine 400 and can include a temperature sensing portion 401 and sensor leads 402. Corresponding leads can be defined in a stock portion 312 (FIG. 3) of the rifle 310. In such an example, the cartridge/magazine thermometer 330B sensor leads 402 can be moved readily in and out of contact with corresponding contacts in the stock, which may in turn be in communication with the computing device or other systems described above. While the catridge/magazine thermometer 330B has been described in the context of an automatic aiming point compensation system, it will be appreciated that the cartridge/magazine thermometer 330B can be utilized independently. For example, the thermometer portion can be configured to provide a visual indication of the temperature directly, such as through the use of a strip which changes colors according to the sensed temperature. Further, the cartridge/magazine sensor can indicate the temperature to an operator in any desired manner and can remain with the magazine 400 as desired.

In the example illustrated in FIG. 4, when viewed from above the magazine 400 includes opposing lateral portions 410 that have a contour that generally parallels the profile of a cartridge of the type the magazine is configured to house. Accordingly, the lateral portions 410, 415 form a neck portion, a shoulder portion, and a base portion that correspond with a neck portion a shoulder portion, and a base portion of the casing respectively.

In addition to defining a profile corresponding to the profile of a cartridge, the lateral portions 410 define a cavity configured to receive a cartridge. As illustrated in FIG. 4, part of the upper ends of the opposing lateral portions 410, 415 can be configured as lips 450, 455 that extend upwardly and inwardly from the opposing lateral portions 410, 415. The detachable magazine 400 can include a follower and biasing member (not shown) configured to urge the cartridges away from the base plate 425 and into engagement with the lips 450, 455.

In the illustrated example, the cartridge/magazine thermometer 330B is shown secured to an exterior portion of the magazine 400. It will be appreciated that the magazine/cartridge sensor 330B, can be position anywhere on or in the magazine 400, including inside the lateral portions 410 or within the cavity described above.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. An optical sighting system, comprising:
an optical sight having a projected aiming point;
a range finder configured to determine a range of an intended impact point;
at least one environmental sensor configured to sense at least one environmental condition; and
a computing device in communication with the range finder and the environmental sensor to receive the range and the environmental condition from the range finder and the environmental sensor respectively, the computing device including a computer readable medium having instructions encoded thereon that when executed perform steps for:
calculating a compensated position for the projected aiming point based on the range and the environmental condition, and
providing instructions to an aimpoint compensator to automatically move the projected aiming point to the compensated position.

2. The optical sight of claim 1, wherein the aimpoint compensator is a mechanical aimpoint compensator configured to mechanically move the optical sight relative to a reference datum.

3. The optical sight of claim 1, wherein the computing device is configured to move a position at which the projected aiming point is projected within the optical sight.

4. The optical sight of claim 1, wherein the computer readable medium includes ballistic tables and reference data stored thereon, the reference data including data correlating previously calculated compensated positions and corresponding environmental conditions corresponding to reference data.

5. The optical sight of claim 1, wherein the computing device is further configured to provide a visual indicator indicating whether a position of the projected aiming point corresponds to the compensated position.

6. The optical sight of claim 5, wherein the visual indicator is displayed within a visual field of the optical sight.

7. The optical sight of claim 1, wherein the environmental sensor includes at least one of a barometer, an ambient thermometer, a cartridge/magazine thermometer, or a wind sensor.

8. A computer product, comprising:
an aimpoint compensator configured to control a position of a projected aiming point of an optical sight relative to a reference datum;
a computer readable media embodied in a physical data storage device; and
a processor operatively associated with the aimpoint compensator and the computer readable media, wherein the computer readable media has instructions encoded thereon that when executed performs steps for:
sensing at least one environmental condition and a range for an intended impact point;
determining a position of the projected aiming point relative to the reference datum;
determining a compensated position based on the range, the environmental condition, and reference data corresponding to a previous intended impact point at a previous range and previous environmental conditions; and
providing instructions for moving the projected aiming point relative to the reference datum to the compensated position

9. The computer product of claim 8, wherein when executed the instructions for moving the projected aiming point relative to the reference datum provide instructions for moving the position of the projected aiming point within the optical sight.

10. The computer product of claim 8, wherein when executed the instructions for moving the projected aiming point relative to the reference datum provide instructions for moving the entire optical sight relative to the reference datum.

11. The computer product of claim 8, wherein when executed the instructions perform a preliminary step of receiving input to cause a position of the projected aiming point relative to the reference datum to correspond to an actual impact point and storing the range, environmental conditions, and the position of the projected aiming point as reference data.

12. The computer product of claim 8, wherein when executed the instructions for sensing the least one condition sense at least one of ambient temperature, cartridge/magazine temperature, or barometric pressure.

13. The computer product of claim 8, wherein the computer readable media also include a ballistics table thereon and when executed the instructions for determining the compensated position based on the range, the environmental condition, and reference data corresponding to the previous intended impact point at the previous range and previous environmental conditions reference the ballistics table.

14. A firearm system, comprising:
a firearm; and
an optical sighting system coupled to the firearm, the optical sighting system including an optical sight having a projected aiming point, a range finder configured to determine a range of an intended impact point, at least one environmental sensor configured to sense at least one environmental condition, a computing device in communication with the range finder and the environmental sensor to receive the range and the environmental condition from the range finder and the environmental sensor respectively, the computing device including a computer readable medium having instructions encoded thereon that when executed perform steps for calculating a compensated position for the projected aiming point based on the range and the environmental condition, and providing instructions to an aimpoint compensator to automatically move the projected aiming point to the compensated position.

15. The firearm system of claim 14, wherein the computing device is integrated in the optical sight.

16. The firearm system of claim 14, further including a detachable magazine having a thermometer coupled thereto, wherein the thermometer is operatively associated with the computing device when the detachable magazine is coupled to the firearm.

17. The firearm system of claim 14, wherein the firearm is a rifle.

18. The firearm system of claim 14, wherein the aimpoint compensator is a mechanical aimpoint compensator configured to mechanically move the optical sight relative to a reference datum.

19. The optical sight of claim 1, wherein the computing device is configured to move a position at which the projected aiming point is projected within the optical sight.
